(19) United States
(12) Patent Application Publication
(10) Pub. No.: US 2009/0198637 A1
(43) Pub. Date: Aug. 6, 2009

(54) METHODS AND PROGRAMS FOR USE CASE MANAGEMENT ACROSS DOMAINS

(75) Inventors: Manaswini Rath, Bangalore (IN); Jon Darling, Phoenix, AZ (US); Mukul Verma, Bangalore (IN)

Correspondence Address: HONEYWELL INTERNATIONAL INC.;PATENT SERVICES, 101 COLUMBIA ROAD, P O BOX 2245, MORRISTOWN, NJ, 07962-2245, US

(73) Assignee: HONEYWELL INTERNATIONAL, INC., Morristown, NJ (US)

(21) Appl. No.: 12/026,892

(22) Filed: Feb. 6, 2008

(51) Int. Cl. G06N 5/00

(52) U.S. Cl. 706/45

(57) ABSTRACT

A method for generating a repository of use cases for developing a solution or evaluating a solution, or both, in a first domain includes the steps of obtaining a first plurality of use cases for the first domain, obtaining a second plurality of use cases for a second domain, and determining a relationship between the second plurality of use cases and the first domain.

### FIELD OF THE INVENTION

The present invention relates generally to the creation, maintenance and application of “Use Cases” and, more particularly, to methods and systems for managing use cases across domains.

### BACKGROUND OF THE INVENTION

In various types of product development and evaluation, use cases are utilized to simulate conditions that may affect a particular solution being developed or tested. A use case generally refers to a set of environmental or other conditions or factors which the user intends to successfully manipulate based on current needs. Specifically, the solution may be considered a system, and a use case may be considered a specific set of conditions external to the system that may have an effect on the system. For any particular solution, there may be numerous different possible use cases, reflecting various different sets of possible external conditions. Use cases generally apply to a particular, domain, such as a particular field or industry (e.g. transportation domains, avionics domains, automotive domains, locomotive domains, industrial domains; refinery domains, pulp & paper domains, manufacturing domains, or medical domains).

For example, in the avionics domain, a solution may comprise an airplane. In this example, a use case may comprise a set of various environmental and/or other conditions that may affect the operation of the airplane. A use case may thus include, by way of example only, an air temperature surrounding the airplane, an amount of cloud cover, a measure of precipitation, a level of visibility, an indication of whether or not other airplanes are being operated nearby, a proximity to an airport, a direction and magnitude of wind proximate the airplane, a geographic location of the airplane, a time of day, a time of year, and/or various other external conditions that may have an effect on the operation of the airplane.

As another example, in the automotive domain, a solution may comprise an automobile, and a use case may comprise a set of environmental conditions that may influence operation of the automobile, such as various weather conditions, conditions of the road, measures of traffic surrounding the vehicle, and/or various other external conditions that may have an effect on the operation of the automobile. As yet another example, in the locomotive domain, a solution may comprise a train, and a use case may comprise a set of environmental conditions that may influence operation of the train, such as various weather conditions, conditions of the railroad tracks, a proximity to a railway station, and/or various other external conditions that may have an effect on the operation of the train.

In these and other domains, a number of sets of use cases can be utilized in developing a particular product or other solution, for example by evaluating a preliminary design of the solution in a computer simulation or other model under external conditions reflected in the sets of use cases. In addition, once the product or other solution is developed, the sets of use cases can be used to test the solution under the external conditions reflected in the sets of use cases, for example by evaluating a prototype of the solution and/or by conducting simulated evaluation using a computer simulation or other model. In such evaluation, the use cases are utilized as inputs in the evaluation process, to test or otherwise simulate how a particular product or other solution is likely to fare under a range of external conditions as reflected in the sets of use cases.

It is generally advantageous to include a large number of use cases in developing and/or evaluating a solution in a particular domain. However, typically use cases are developed and maintained on an ad hoc basis for a particular domain or for a particular solution within a domain. This can make it difficult, time consuming, and costly to develop and implement a broad array of use cases for developing and/or evaluating the solution, and it can lead to the use of an incomplete set of use cases.

Accordingly, it is desirable to provide improved methods for creating, maintaining, and/or applying uses cases for developing and/or evaluating a solution in a given domain. It is also desirable to provide program products for improved creation, maintenance, and/or application of uses cases for developing/evaluating a solution in a given domain. Furthermore, the desirable features and characteristics of the present invention will be apparent from the subsequent detailed description and the appended claims, taken in conjunction with the accompanying drawings and the foregoing technical field and background.

### BRIEF SUMMARY OF THE INVENTION

In accordance with an exemplary embodiment of the present invention, a method for generating a repository of use cases for developing a solution, evaluating a solution, or both, in a first domain is provided. The method comprises the steps of obtaining a first plurality of use cases for the first domain, obtaining a second plurality of use cases for a second domain, and determining a relationship between the second plurality of use cases and the first domain.

In accordance with another exemplary embodiment of the present invention, a program product for generating a repository of use cases for developing a solution or evaluating a solution, or both in a first domain is provided. The program product comprises a program and a computer-readable signal-bearing media. The program is configured to at least facilitate obtaining a first plurality of use cases for the first domain, obtaining a second plurality of use cases for a second domain, and determining a relationship between the second plurality of use cases and the first domain. The computer-readable signal-bearing media bears the program.

In accordance with a further exemplary embodiment of the present invention, a method for preparing a set of use cases to evaluate a solution or test a solution, or both, in a first domain is provided. The method comprises the steps of determining which of a first plurality of use cases pertaining to the first domain are applicable for the solution, to thereby select a first plurality of applicable use cases, and determining which of a second plurality of use cases pertaining to a second domain are applicable for the solution, to thereby select a second plurality of applicable use cases. The second plurality of applicable use cases is selected based at least in part on a relationship between the second plurality of use cases and the first domain.

In accordance with yet another exemplary embodiment of the present invention, a program product for preparing a set of use cases to develop a solution or test a solution, or both, in a first domain is provided. The program product comprises a program and a computer-readable signal-bearing media. The program is configured to at least facilitate determining which of a first plurality of use cases pertaining to the first domain are applicable for the solution, to thereby select a first plurality of applicable use cases, and determining which of a second plurality of use cases pertaining to a second domain are applicable for the solution, to thereby select a second plurality of applicable use cases. The second plurality of applicable use cases is selected based at least in part on a relationship between the second plurality of use cases and the first domain.

In accordance with a further exemplary embodiment of the present invention, a use case management system is provided. The use case management system comprises a repository of use cases for developing a solution or evaluating a solution, or both, in a plurality of domains, and a server module. The repository of use cases comprises a first plurality of use cases from a first domain, a second plurality of use cases from a second domain, and a relationship between the first plurality of use cases and the second domain. The server module is coupled to the repository, and is configured to allow a user to interface with the repository.

### BRIEF DESCRIPTION OF THE DRAWINGS

The present invention will hereinafter be described in conjunction with the following drawing figures, wherein like numerals denote like elements, and:

FIG. 1 is a flowchart of a process for generating a repository of use cases across domains for developing and/or evaluating a solution in a first domain, in accordance with an exemplary embodiment of the present invention;

FIG. 2 is a flowchart of a process for preparing a set of use cases across domains to test a solution in a first domain, in accordance with an exemplary embodiment of the present invention;

FIG. 3 is a functional block diagram of a computer system that can be used to implement the processes of FIGS. 1 and 2, in accordance with an exemplary embodiment of the present invention;

FIG. 4 is a depiction of a sequence of screen displays for an interface, such as an interface of the computer system of FIG. 3, and that can be used in connection with the process of FIG. 2, in accordance with an exemplary embodiment of the present invention; and

FIG. 5 depicts a system for managing use cases, that can be used in implementing the processes of FIG. 1 and FIG. 2, that can utilize the computer system of FIG. 3, and that can implement the sequence of displays of FIG. 4, in accordance with an exemplary embodiment of the present invention.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

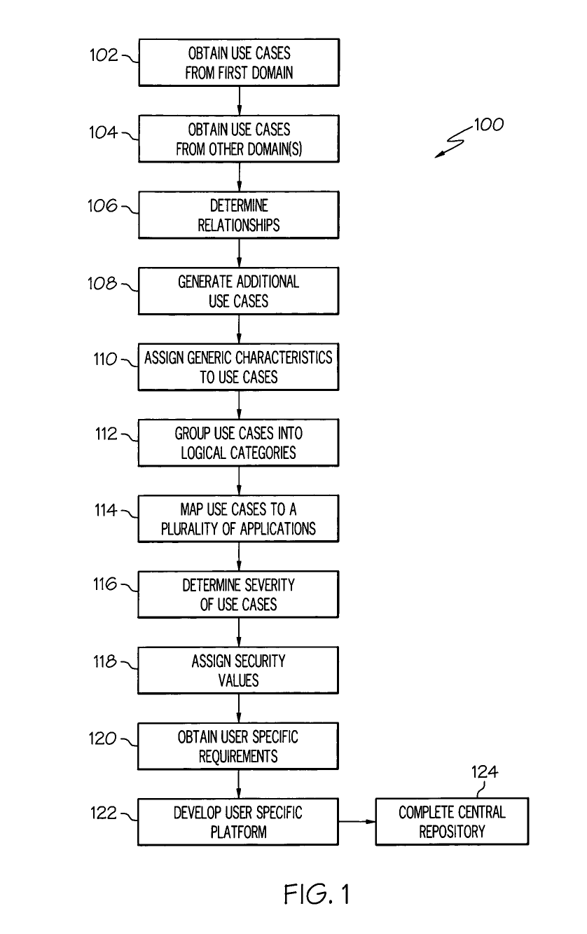

FIG. 1 is a flowchart of a first process 100 for generating a repository of use cases across domains for developing and/or evaluating a solution in a first domain, in accordance with an exemplary embodiment of the present invention. In one exemplary embodiment, the domain comprises an avionics domain. In such an exemplary embodiment, a solution may comprise an airplane, a helicopter, another type of aircraft, and/or a combination and/or fleet thereof. However, in other embodiments, the first domain may comprise another type of domain, such as an automotive domain, a locomotive domain, a medical domain, and/or any one of a number of other different types of domains, and the solutions may also vary accordingly.

As depicted in FIG. 1, the first process 100 begins with the step of obtaining use cases from the first domain (step 102). The use cases may be obtained using any one or more of a number of different techniques. For example, the use cases may be obtained by utilizing an existing database of use cases for the first domain, by reviewing periodicals, manuals, literature, or other publications or information pertaining to the first domain, by trial and error, by first hand experience of one or more individuals, devices, and/or systems, and/or by any one or more of a number of other different techniques.

In the above-referenced exemplary embodiment in which the first domain comprises an avionics domain, the use cases may comprise various sets of environmental and/or other conditions that may affect the operation of the airplane, such as, by way of example only, an air temperature surrounding the airplane, an amount of cloud cover, a measure of precipitation, a level of visibility, an indication of whether or not other airplanes are being operated nearby, a proximity to an airport, a direction and magnitude of wind proximate the airplane, a geographic location of the airplane, a time of day, a time of year, and/or various other external conditions that may have an effect on the operation of the airplane. Preferably, a large number of use cases are obtained for the first domain.

Next, use cases are obtained for one or more additional domains (step 104). The use cases for the one or more additional domains may similarly be obtained using any one or more of a number of different techniques such as, by way of example only, by utilizing an existing database of use cases for the one or more additional domains, by reviewing periodicals, manuals, literature, or other publications or information pertaining to the one or more additional domains, by trial and error, by first hand experience of one or more individuals, devices, and/or systems, and/or by any one or more of a number of other different techniques.

In the above-referenced exemplary embodiment in which the first domain comprises an avionics domain, the one or more additional domains may comprise an automotive domain and a locomotive domain, with respective solutions comprising an automobile, a truck, a motorcycle, and/or various other different types of land vehicles or fleets or combinations thereof (for the automotive domain), and various types of trains or fleets or combinations thereof (for the locomotive domain). In such an exemplary embodiment, the use cases for the automotive domain may comprise, by way of example only, a set of environmental conditions facing operation of the automobile, such as various weather conditions, conditions of the road, measures of traffic surrounding the vehicle, and/or various other external conditions that may have an effect on the operation of the automobile. The use cases for the locomotive domain in such an exemplary embodiment may comprise, by way of example only, a set of environmental conditions facing operation of the train, such as such as various weather conditions, conditions of the railroad tracks, a proximity to a railway station, and/or various other external conditions that may have an effect on the operation of the train.

In a preferred embodiment, use cases are obtained from a large number of additional domains, to facilitate the creation of a central repository of use cases across a large number of different domains. It will be appreciated that steps 102 and 104 may be performed simultaneously or in either order. It will similarly be appreciated that various other steps of the first process 100 may also be conducted simultaneously or in a different order than that depicted in FIG. 1 and/or described herein.

One or more relationships are then determined between the use cases in the first domain and the use cases in the one or more additional domains (step 106). For example, in the above-referenced exemplary embodiment in which the first domain comprises an avionics domain and the one or more additional domains comprise an automotive domain and a locomotive domain, various use cases from the automotive and locomotive domains can be used to fine tune, adjust, or otherwise enhance the use cases for the new domain. These relationships may also be used to fine tune, adjust, or otherwise enhance the use cases in the additional domains, also based on the relationship. Additional relationships may also be determined between the use cases in the additional domains (for example, between use cases across different additional domains), for example to further fine tune or otherwise enhance the use cases for the additional domains as well based on these additional relationships.

Also, in a preferred embodiment, additional use cases are generated based at least in part on the relationships (step 108). Preferably, additional use cases are generated at least for the first domain based on the relationships. Additional use cases may similarly be generated for the additional domains based on the relationships, and/or the additional relationships between use cases in these and/or other domains.

In the above-referenced exemplary embodiment in which the first domain comprises an avionics domain and the additional domains comprise an automotive domain and a locomotive domain, for example, use case information in the locomotive or automotive domains regarding a particular type of storm or other weather conditions as they may affect a train or an automobile may be used to generate a relationship to fine tune or adjust an applicable use case in the avionics domain, for example as to how such a particular type of storm or other weather conditions may affect an airplane. Known relationships or similarities between solutions in the different domains (for example, between airplanes, locomotives, and automobiles) may also be used in this process.

As another example in this exemplary embodiment, the relationship may represent an interaction between the products or solutions of the different domains. For example, an exemplary use case for the first domain pertaining to operation of an airplane (or another solution from a first domain) may include, as external factors, the presence or operation of locomotives or automobiles nearby (or other solutions from additional domains). As another example, an exemplary use case for a train in a locomotive domain may include, as an external factor, the presence or operation of a nearby automobile, for example near a railroad/street crossing or otherwise near railroad tracks on which the train is being operated.

In one embodiment also featuring a medical domain, various medical-related use cases may also be relevant to each of these domains. For example, the health or other medical conditions of an individual operating a particular type of vehicle may be utilized in developing and/or fine tuning use cases for that particular type of vehicle, and/or for other types of vehicles in other domains, and/or for various other types of solutions in various other different types of domains. It will be appreciated that various other different types of relationships may also be utilized in various manners within or between the above-described domains and/or within or between various other different types of domains.

In a preferred embodiment, generic characteristics are assigned to each of the use cases (step 110). Preferably, the generic characteristics represent characteristics that can easily be applied across different domains. For example, the use of generic keywords or tags with applicability across different domains can be used to facilitate the determination and implementation of the various relationships between use cases across different domains. Also in a preferred embodiment, the use cases are grouped into logical categories (step 112), to further facilitate the determination and implementation of the various relationships between use cases across different domains.

The use cases are also preferably mapped to a plurality of applications (step 114). For example, the use cases for a particular domain may be mapped to different solutions within the domain, and to different applications for each of the different solutions. In the above-referenced exemplary embodiment in which the first domain comprises an avionics domain and the additional domains comprise an automotive domain and a locomotive domain, for example, the different use cases for the avionics domain may be mapped to different types of aircraft as maintained, operated and/or otherwise used in different manners and/or under different conditions. Similarly, the different use cases for the automotive and locomotive domains may be mapped to different types of automobiles and trains, respectively, as maintained, operated and/or otherwise used in different manners and/or under different conditions. In certain embodiments the mapping may be conducted only with respect to the use cases for the first domain. However, in a preferred embodiment, the mapping is conducted for each of the use cases for each of the domains.

In addition, preferably a severity level is determined for the various use cases (step 116). For example, the severity level may include a generic measure of how significantly the external conditions reflected in the use case may affect the solution in the applicable domain, such as how particular weather conditions, road conditions, and/or other conditions may affect operation of a vehicle. The severity level may include, in addition to or instead of such a generic measure, a more specific measure of how significantly the external conditions reflected in the use case may affect a particular type application of a particular solution in the applicable domain, such as how particular weather conditions, road conditions, and/or other conditions may affect operation of a particular year, make, and/or model vehicle, and/or as operated by a particular type of driver and/or with a particular type of driving pattern. In certain embodiments the severity may be determined only with respect to the use cases for the first domain. However, in a preferred embodiment, the severity level is determined for each of the use cases for each of the domains. Also, it will be appreciated that any number of different types of severity levels may be determined and/or utilized in any number of different ways in various embodiments.

Also in a preferred embodiment, one or more security values are assigned to the various use cases (step 118). The security values can be used to help subsequently determine which use cases are to be made available to one or more particular users or groups of users. In certain embodiments, different security values may be assigned to different use cases or groups thereof, to facilitate such determinations. In a preferred embodiment, particular users may be allowed access to use cases in certain domains but not others, depending upon the authorized access of the particular user (and, preferably, depending on which domain(s) the user is authorized to access and/or view). This allows for a single repository of use cases for multiple domains without allowing users to access unauthorized domains. For example, if a particular user will be authorized to access use cases only in the aircraft and automotive domains, then use cases in these domains may be labeled with one or more particular security values, and use cases in other domains may be assigned different security values. The assignment of security values may vary, for example based on the particular users and/or groups of users. The assignment, use, and implementation of the security values may also otherwise vary in different embodiments of the present invention.

In addition, in certain embodiments, user specific requirements are obtained (step 120), and a user specific platform is developed (step 122). The user requirements may be used to customize and/or tailor a repository of use cases to meet the user's needs and desires in a particular platform. For example, if a particular user manufactures a particular product line in the first domain, the use cases and platform may be tailored to the manufacturer's particular line of products. Similarly, if the user typically uses a particular range of products in certain geographic conditions (for example, for vehicles that are sold primarily in a particular country or region of the world) and/or under certain environmental conditions (for example, equipment or gear that is typically used by firefighters while fighting fires), the user specific platform may be tailored accordingly.

The central repository of use cases is then completed (step 124). Preferably, the central repository comprises a large number of use cases from a large number of domains, and incorporates various relationships therebetween. In certain embodiments, the central repository of use cases and one or more user specific platforms are integrated together. In other embodiments, the central repository of use cases may exist as a separate physical entity that can be coupled to such one or more user specific platforms. In yet other embodiments, the central repository of use cases may exist independent of or without a user specific platform.

The central repository of use cases and the user specific platform (if applicable) can be used in developing a particular product or other solution, for example by evaluating a preliminary design of the solution in a computer simulation or other model under external conditions reflected in the sets of use cases. In addition, once the product or other solution is developed, the sets of use cases can be used to test the solution under these external conditions reflected in the sets of use cases, for example by evaluating a prototype of the solution and/or by conducting simulated evaluation using a computer simulation or other model. In such evaluation, the use cases are utilized as inputs in the evaluation process, to test or otherwise simulate how a particular solution is likely to fare under a range of external conditions as reflected in the sets of use cases.

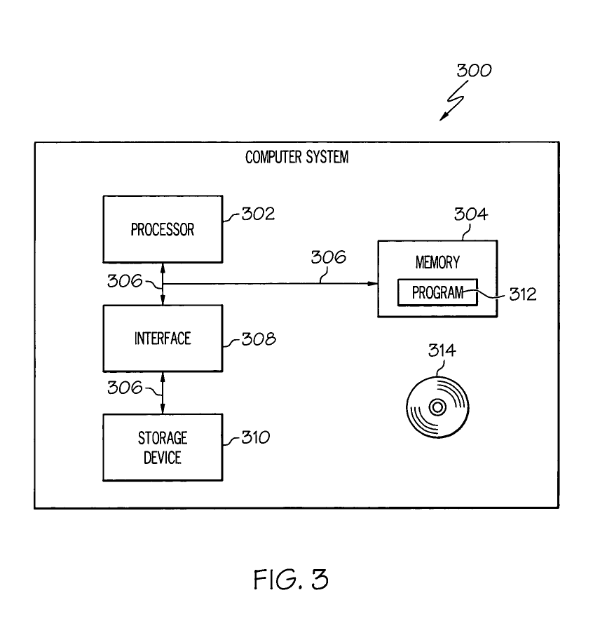

In a preferred embodiment, the various steps of the first process 100 are performed by a processor of a computer system, such as the exemplary processor of the exemplary computer system depicted in FIG. 3 and described further below in connection therewith. The various inputs, use cases, requirements, security values, and other values are preferably stored in a memory, such as the exemplary memory of the computer system depicted in FIG. 3 and described further below in connection therewith.

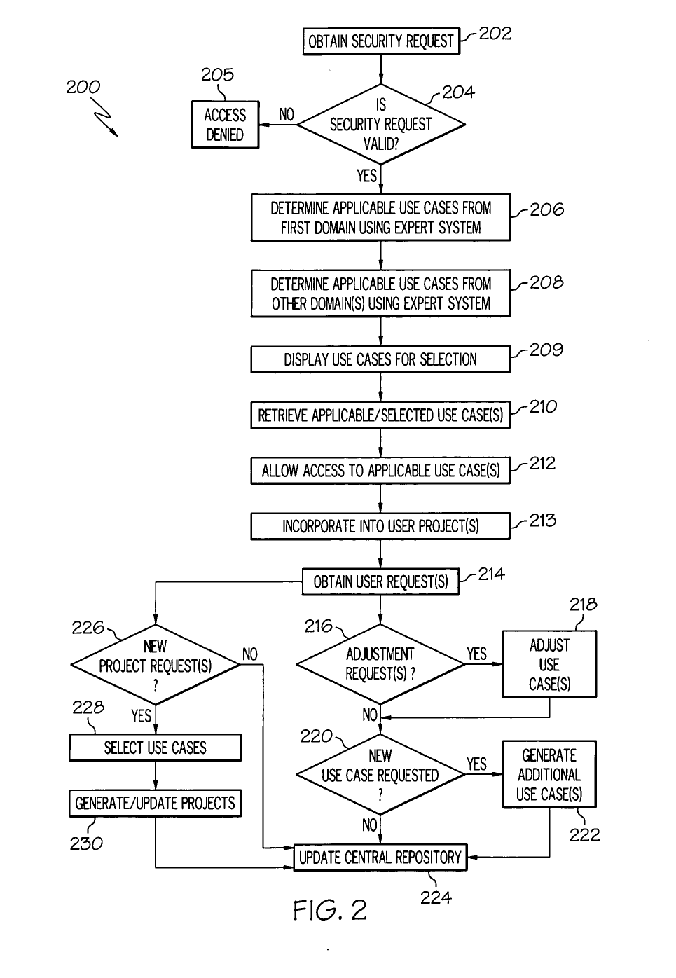

FIG. 2 is a flowchart of a second process 200 for preparing a set of use cases across domains to test a solution in a first domain, in accordance with an exemplary embodiment of the present invention. In one exemplary embodiment, the domain comprises an avionics domain. In such an exemplary embodiment, a solution may comprise an airplane, a helicopter, another type of aircraft, and/or a combination and/or fleet thereof. However, in other embodiments, the first domain may comprise another type of domain, such as an automotive domain, a locomotive domain, a medical domain, and/or any one of a number of other different types of domains, and the solutions may also vary accordingly.

As depicted in FIG. 2, the second process 200 begins with the step of obtaining a security request from a user (step 202). In a preferred embodiment, the security request pertains to which, if any, of the use cases in a central repository of use cases the user is allowed to have access to. By way of example only, the security request may include the insertion of a security card, the input of a sequence of letters or numbers or another type of code, user identification, and/or password, the use of biometric devices and techniques, and/or the use of any one or more of a number of different types of techniques. Also in a preferred embodiment, the central repository of use cases is of the type described above in connection with the first process 100 of FIG. 1, and the use cases are assigned security values in a manner such as those described above in connection with the first process 100. However, this may vary in other embodiments.

Next, a determination is made as to whether the security request is valid (step 204). If it is determined in step 204 that the security request is invalid, then access is denied (step 205). Specifically, the user is not allowed to access any of the use cases. Also in certain embodiments, one or more additional security measures may also be taken in this event. In other embodiments, the user may be given another chance to provide a valid security request, and/or various other measures may be taken.

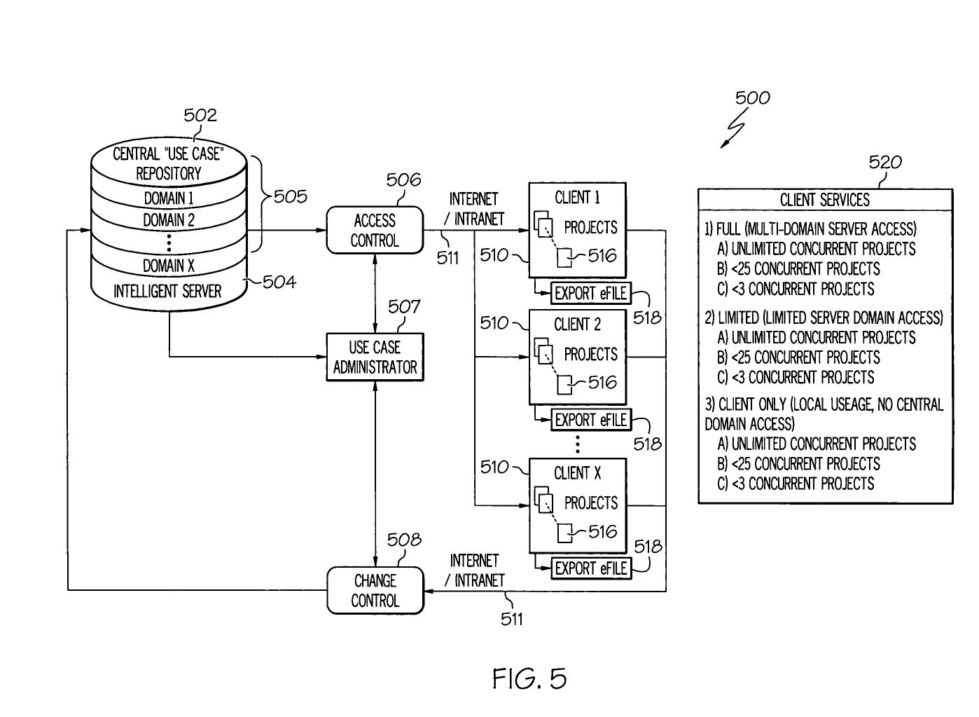

Conversely, if it is determined in step 204 that the security measure is valid, then the process proceeds to step 206, in which a determination is made as to which use cases the user will be granted access to in a first domain. Preferably this determination is made by an expert system, such as the system depicted in FIG. 5 and described further below in connection therewith. Also, in the above-referenced exemplary embodiment in which the first domain comprises an avionics domain, the use cases may comprise various sets of environmental and/or other conditions that may affect the operation of the airplane, such as, by way of example only, an air temperature surrounding the airplane, an amount of cloud cover, a measure of precipitation, a level of visibility, an indication of whether or not other airplanes are being operated nearby, a proximity to an airport, a direction and magnitude of wind proximate the airplane, a geographic location of the airplane, a time of day, a time of year, and/or various other external conditions that may have an effect on the operation of the airplane.

Next, a determination is made as to which use cases the user will be granted access to in one or more additional domains (step 208). Preferably this determination is made by an expert system, such as the system depicted in FIG. 5 and described further below in connection therewith. Also, in the above-referenced exemplary embodiment in which the first domain comprises an avionics domain, the one or more additional domains may comprise an automotive domain and a locomotive domain, with respective solutions comprising an automobile, a truck, a motorcycle, and/or various other different types of land vehicles or fleets or combinations thereof (for the automotive domain), and various types of trains or fleets or combinations thereof (for the locomotive domain). In such an exemplary embodiment, the use cases for the automotive domain may comprise, by way of example only, a set of environmental conditions facing operation of the automobile, such as various weather conditions, conditions of the road, measures of traffic surrounding the vehicle, and/or various other external conditions that may have an effect on the operation of the automobile. The use cases for the locomotive domain in such an exemplary embodiment may comprise, by way of example only, a set of environmental conditions facing operation of the train, such as such as various weather conditions, conditions of the railroad tracks, a proximity to a railway station, and/or various other external conditions that may have an effect on the operation of the train.

It will be appreciated that steps 206 and 208 may be performed simultaneously or in either order. It will similarly be appreciated that various other steps of the second process 200 may also be conducted simultaneously or in a different order than that depicted in FIG. 2 and/or described herein.

Also in a preferred embodiment, an index or listing of the applicable use cases is displayed for the user, and the user is allowed to select certain applicable use cases to be displayed (step 209). The applicable use cases are then retrieved (step 210), and the user is granted access to these applicable use cases (step 212). For example, in a preferred embodiment, the use cases that are retrieved, and for which the user is granted access, comprise use cases stored in a central repository of use cases across multiple domains, such as that described above in connection with the first process 100 of FIG. 1.

Also in a preferred embodiment, the displayed use cases include those selected by the user in step 209, and/or other use cases that may be relevant to one or more desired user projects. The use cases and/or information pertaining thereto can then be incorporated into the one or more desired user projects (step 213). Such a desired user project, for example, may represent a particular product or other solution within a domain, a particular application of such product or other solution, and/or evaluation with respect to a particular set of environmental conditions or other use cases, among various other possible types of user projects. It will be appreciated that in various embodiments the desired user projects may take any one or more of a number of different forms.

Next, one or more user requests are obtained, if applicable, from the user (step 214). For example, the user may wish to fine tune one, customize, or otherwise change or adjust one or more of the use cases, and/or the user may wish to add one or more new, additional use cases. A determination is then made as to whether or not the user has requested an adjustment to one or more use cases (step 216). For example, a user may wish to adjust a particular use case based on personal experience, a new article or other information in the literature, new developments, a change in geographic location that might require modification to a particular use case, and/or for any one of a number of different reasons.

If it is determined in step 216 that the user has requested an adjustment to one or more use cases, then the one or more use cases are adjusted accordingly, (step 218), after which the process proceeds to step 220, as described below. Conversely, if it is determined in step 216 that the user has not requested an adjustment to one or more use cases, then no adjustments are made, and the process instead proceeds directly to step 220.

In step 220, a determination is made as to whether or not the user has made a request for one or more additional use cases. For example, a user may wish to add a new use case based adjust a particular use case based on personal experience, a new article or other information in the literature, new developments, a change in geographic location that may require a new use case, and/or for any one of a number of different reasons. If it is determined in step 220 that the user has made a request for one or more additional use cases, then one or more new, additional use cases are created accordingly, (step 222). Conversely, if it is determined in step 220 that the user has not made a request for one or more additional use cases, then no new, additional use cases are added.

The central repository of use cases is then updated (step 224), based on any adjustments made to any of the use cases and any new, additional use cases that have been generated. In certain embodiments, the central repository of use cases may also be updated pursuant to any other requests that may have been made by the user, by any new use cases that may have otherwise been generated or obtained, by any tracking of the user's use of the central repository that may be required or desired, and/or in accordance with one or more other manners, guidelines, or techniques. For example, if the user has requested to access or edit a user profile of the user, or to add, delete, edit, view, cancel, or finish a project, or if the user has made any other types of requests, such requests may similarly be used in updating the central repository and/or a user platform used in connection therewith. In certain embodiments the central repository may not be updated, regardless of any requests made by the user. For example, in certain such embodiments, such changes may be made only with respect to the particular platform accessed by the user, rather than to the central repository. In yet other embodiments, changes may not be made at the request of the user, for example without prior authorization or a change authorization process.

Similar to the discussion above, the use cases accessed by the user can be used by the user in developing or evaluating a particular product or other solution, for example by evaluating a preliminary design of the solution in a computer simulation or other model under external conditions reflected in the sets of use cases. In addition, once the product or other solution is developed, the sets of use cases can be used to test the solution under these external conditions reflected in the sets of use cases, for example by evaluating a prototype of the solution and/or by conducting simulated evaluation using a computer simulation or other model. In such evaluation, the use cases may be utilized as inputs in the evaluation process, to test or otherwise simulate how a particular solution is likely to fare under a range of external conditions as reflected in the sets of use cases.

In addition, a determination is made as to whether the user has requested any new projects and/or any adjustments to and/or management of any new or existing projects, using the cases (step 226). If it is determined that the user has made such a request, then applicable use cases are selected for such project(s) (step 228), and the projects are generated and/or adjusted accordingly using these use cases (step 230). For example, in one preferred embodiment, projects are created and/or adjusted by dragging and dropping appropriate use cases from the central repository and allotting the same to the project. These allocated use cases are preferably used for the design and development of the project, and ultimately also for the validation of the project. In either case, the process then preferably returns to the above-described step 224, in which the central repository of use cases is updated.

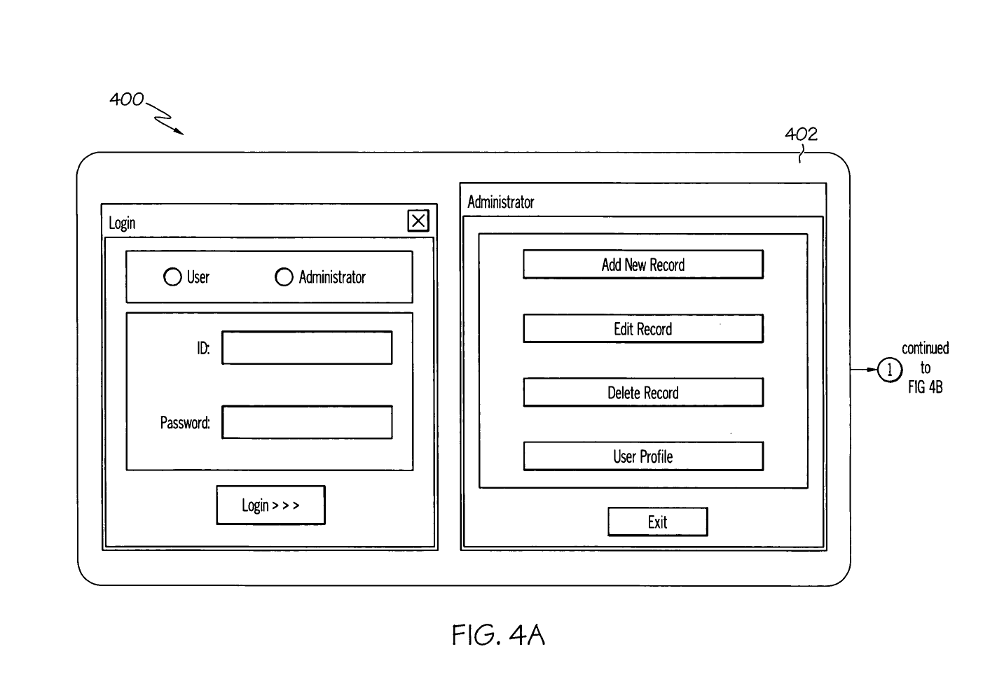

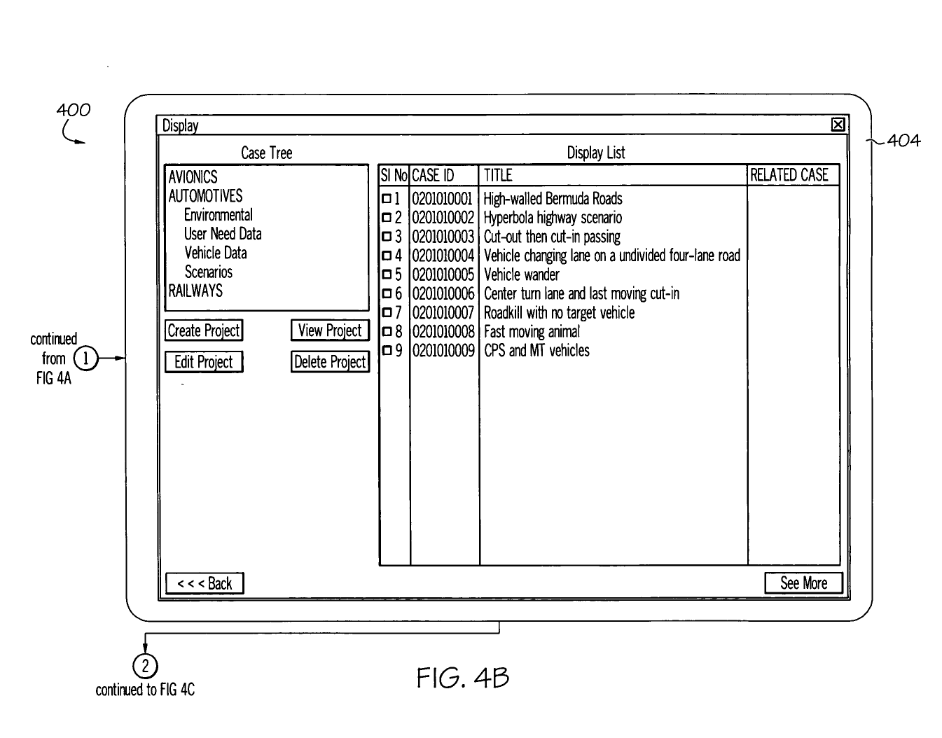

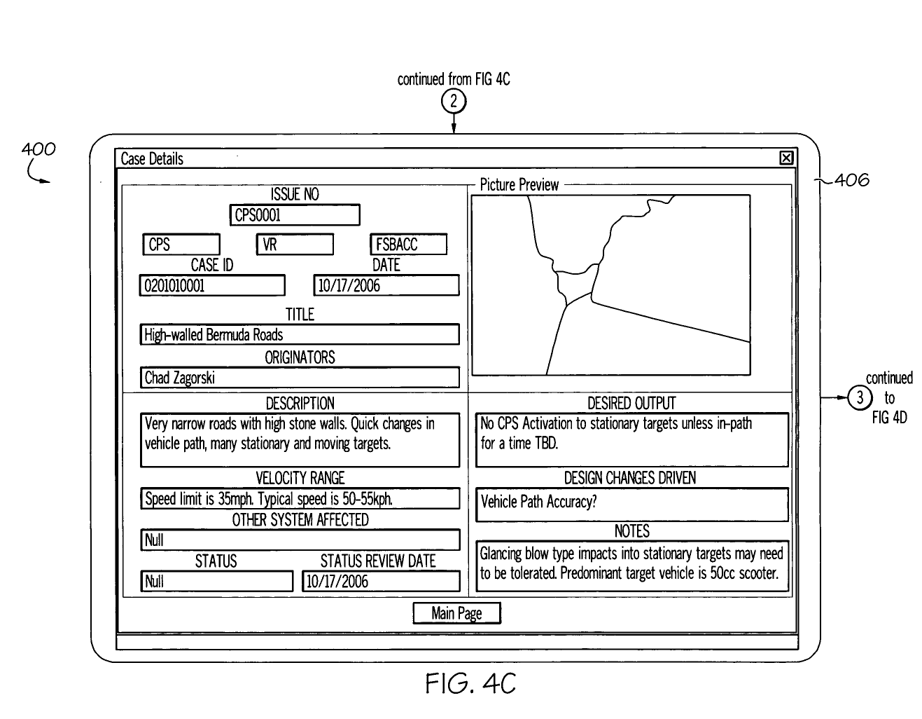

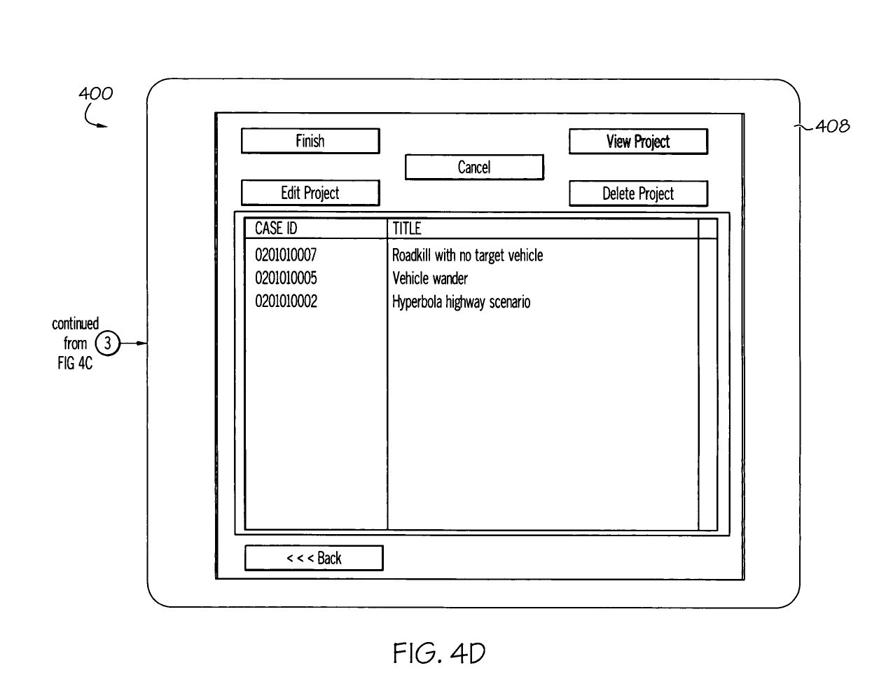

Also in a preferred embodiment, the various determinations and other steps of the second process 200 are performed by a processor of a computer system, such as the exemplary processor of the exemplary computer system depicted in FIG. 3 and described below in connection therewith. The various inputs, use cases, requirements, requests, security values, and other values are preferably stored in a memory, such as the exemplary memory of the computer system depicted in FIG. 3. In addition, the applicable use cases are preferably displayed and the user requests are preferably received using an interface, such as the exemplary interface of the exemplary computer system of FIG. 3. The interface preferably includes various sequences of screen displays, such as the exemplary sequence of screen displays depicted in FIG. 4 and described further below in connection therewith.

FIG. 3 is a functional block diagram of a computer system 300 that can be used to implement the first process 100 of FIG. 1 and the second process 200 of FIG. 2, in accordance with an exemplary embodiment of the present invention. For example, in one embodiment, one computer system 300 (or a group of computer systems) can be configured to implement the first process 100 of FIG. 1, and another computer system 300 (or another group of computer systems) can be configured to implement the second process 200 of FIG. 2. In other embodiments, one computer system 300 (or a group of computer systems) can be used to implement both the first process 100 of FIG. 1 and the second process 200 of FIG. 2. Also, as described below, in a preferred embodiment, such computer system(s) are capable of having a software program product stored therein, for example to execute the first process 100 and/or the second process 200. It will be appreciated that these processes may also be implemented in connection with any one or more of a number of other different types of computer systems and/or other systems and/or devices.

In the depicted embodiment, the computer system 300 includes a processor 302, a memory 304, a bus 306, an interface 308, and a storage device 310. The processor 302 performs the computation and control functions of the computer system 300, and may comprise any type of processor or multiple processors, single integrated circuits such as a microprocessor, or any suitable number of integrated circuit devices and/or circuit boards working in cooperation to accomplish the functions of a processing unit. During operation, the processor 302 executes one or more programs 312 preferably stored within the memory 304 and, as such, controls the general operation of the computer system 300.

In one embodiment, the memory 304 stores a program or programs 312 that executes one or more embodiments of the first process 100 of FIG. 1 and/or the second process 200 of FIG. 2. The memory 304 can be any type of suitable memory. The memory 304 may include one or more of various types of dynamic random access memory (DRAM) such as SDRAM, the various types of static RAM (SRAM), and the various types of non-volatile memory (PROM, EPROM, and flash). It should be understood that the memory 304 may be a single type of memory component, or it may be composed of many different types of memory components. In addition, the memory 304 and the processor 302 may be distributed across several different computers that collectively comprise the computer system 300. For example, a portion of the memory 304 may reside on a computer within a particular apparatus or process, and another portion may reside on a remote computer.

The bus 306 serves to transmit programs, data, status and other information or signals between the various components of the computer system 300. The bus 306 can be any suitable physical or logical means of connecting computer systems and components. This includes, but is not limited to, direct hard-wired connections, fiber optics, infrared and wireless bus technologies.

The interface 308 allows communication to the computer system 300, for example from a system driver and/or another computer system, and can be implemented using any suitable method and apparatus. It can include one or more network interfaces to communicate with other systems or components. The interface 308 may also include one or more network interfaces to communicate with technicians, and/or one or more storage interfaces to connect to storage apparatuses, such as the storage device 310. In a preferred embodiment, the interface 308 includes various screen displays to assist a user in interfacing with the computer system 300. An exemplary embodiment of a sequence of such screen displays in connection with the second process 200 of FIG. 2 is depicted in FIG. 4 and will be described further below in connection therewith. It will be appreciated that in various embodiments that the interface 308 may utilize different screen display sequences and/or various other different features and techniques in implementing the first process 100 of FIG. 1 and the second process 200 of FIG. 2.

The storage device 310 can be any suitable type of storage apparatus, including direct access storage devices such as hard disk drives, flash systems, floppy disk drives and optical disk drives. In one exemplary embodiment, the storage device 310 comprises a program product from which memory 304 can receive a program 312 that executes one or more embodiments of one or more processes of the present invention, such as the first process 100 of FIG. 1 and/or the second process 200 of FIG. 2. In another exemplary embodiment, the program product may be directly stored in and/or otherwise accessed by the memory 304 and/or a disk such as that referenced below. As shown in FIG. 3, the storage device 310 can comprise a disk drive device that uses disks 314 to store data. As one exemplary implementation, the computer system 300 may also utilize an Internet website, for example for providing or maintaining data or performing operations thereon.

It will be appreciated that while this exemplary embodiment is described in the context of a fully functioning computer system, those skilled in the art will recognize that the mechanisms of the present invention are capable of being distributed as a program product in a variety of forms, and that the present invention applies equally regardless of the particular type of computer-readable signal bearing media used to carry out the distribution. Examples of signal bearing media include: recordable media such as floppy disks, hard drives, memory cards and optical disks (e.g., disk 314), and transmission media such as digital and analog communication links. It will similarly be appreciated that the computer system 300 may also otherwise differ from the embodiment depicted in FIG. 3, for example in that the computer system 300 may be coupled to or may otherwise utilize one or more remote computer systems and/or other control systems.

FIG. 4 is a depiction of a sequence 400 of screen displays for an interface, such as the interface 308 of FIG. 3, and that can be used in connection with the second process 200 of FIG. 2, in accordance with an exemplary embodiment of the present invention. In the depicted embodiment, the sequence 400 of screen displays includes a first display 402, a second display 404, a third display 406, and a fourth display 408.

The first display 402 allows the user to input a security request or related information, such as a user identification and password (for example, corresponding to step 202 of the second process 200 of FIG. 2). Also in the depicted embodiment, the first display 402 may allow the user to make various requests, such as a request to add, edit, or delete a use case or other record, and/or to access or update a user profile (for example, corresponding to step 216 of the second process 200 of FIG. 2). The second display 404 provides the user with a menu for selection of applicable use cases for display (for example, corresponding to step 209 of the second process 200 of FIG. 2). The third display 406 allows the user to access the particular use case(s) (for example, corresponding to step 212 of the second process 200 of FIG. 2). For example, as shown in the depicted embodiment, the third display 406 may display various pictorial and/or written description of an applicable use case or information pertaining thereto. The fourth display 408 allows the user to incorporate the applicable use cases into one or more user projects, and/or to complete, edit, cancel, or delete the project (for example, corresponding to step 213 of the second process 200 of FIG. 2). While an exemplary sequence 400 of screen displays is depicted in FIG. 4, it will be appreciated that the screen displays may utilize any number of other different types of screen displays and/or other user interface displays, devices, and/or techniques.

FIG. 5 depicts a system 500 for managing use cases, in accordance with an exemplary embodiment of the present invention. The system 500 can be used in implementing the first process 100 of FIG. 1 and the second process 200 of FIG. 2, in a preferred embodiment. Also in a preferred embodiment, the expert system 500 utilizes a computer system such as the computer system 300 of FIG. 3, and implements displays such as the sequence 400 of displays of FIG. 4.

As shown in FIG. 5, in the depicted embodiment the system 500 comprises a central repository 502 of use cases and a server module 504. The system 500 is preferably an expert system, with a central repository 502 that comprises a large number of use cases from a large number of different domains 505. Specifically, the central repository 502 preferably includes or stores a large number of different pluralities of use cases, with each plurality of use cases comprising a large number of use cases applying to a different domain 505. In addition, the central repository 502 preferably includes or stores a number of relationships between each plurality of use cases of a corresponding domain 505 and different domains 505 and/or between each plurality of use cases of a corresponding domain 505 and different pluralities of use cases from different domains 505. For example, in preferred embodiment, the central repository 502 includes a first plurality of use cases from an avionics domain 505, a second plurality of use cases from an automobile domain 505, and various additional pluralities of use cases from other, different domains 505, along with relationships between and among the different pluralities of use cases and respective domains 505.

The server module 504 includes one or more servers, and is configured to allow a user, such as a client 510, to interface with the central repository 502. Preferably, the server 504 is further configured to at least facilitate receiving instructions from the user and managing the repository in accordance with the instructions, as well as to at least facilitate customizing the repository in accordance with the instructions. In addition, the server module 504 is preferably further configured to at least facilitate implementing the security features and other features of the first process 100 of FIG. 1 and the second process 200 of FIG. 2, through the use of the access control 506, use case administrator 507, and the change control 508 functions of the expert system 500. For example, in one preferred embodiment, the server module is configured to at least facilitate obtaining a security measure from a user, and allowing the user to access the first plurality of applicable use cases or the second plurality of applicable use cases, or both, only if the security measure is valid, in addition to the other features of the first process 100 of FIG. 1 and the second process 200 of FIG. 2.

As depicted in FIG. 5, in a preferred embodiment the expert system 500 also includes an access control function 506, a use case administrator 507, and a change control function 508, each of which are preferably operated or controlled at least in part by the server module 504. The access control feature 506 is coupled to interface with various clients 510, such as an Internet or Intranet connection, and provides appropriate access to the clients 510 for the central repository 502. The change control feature 508 is similarly coupled to interface with various clients 510 via the connection 511, and receives information pertaining to the clients' 510 projects 516, files 518, and/or requests via the connection 511. The use case administrator then processes such requests, preferably through the control of the server module 504. The server module 504 thereby allows for the implementation of such requests, which may include, by way of example, adjustments to the use case repository, generation of or adjustments to use cases, and/or the generation or updating of client projects, for example as described above in connection with the first process 100 of FIG. 1 and the second process 200 of FIG. 2.

For example, preferably the expert system 500 understands the characteristics and behavior of any new or existing project, and/or other use case management, by observing the series of use cases that the user allots to particular project(s). Based on the observation, the expert system 500, and preferably the server module 504 thereof, searches other related use cases within the central repository 502 and provides the list of options to select more related use cases for the project. The user (for example, one of the clients 510 represented in FIG. 5) then has the choice of selecting the appropriate use cases for the defined project. The system 500 can similarly receive and implement various other commands and requests from the user, for example as described in connection with first process 100 of FIG. 1 and the second process 200 of FIG. 2. The system 500 also preferably implements the security features (for example, only allowing the user to access use cases to particular domains for which the user is an authorized user) and other features as described above in connection with first process 100 of FIG. 1 and the second process 200 of FIG. 2.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims and their legal equivalents

We claim:

1. A method for generating a repository of use cases for developing a solution or evaluating a solution, or both, in a first domain, the method comprising the steps of:
obtaining a first plurality of use cases for the first domain;
obtaining a second plurality of use cases for a second domain; and
determining a relationship between the second plurality of use cases and the first domain.

2. The method of claim 1, further comprising the step of:
assigning a generic characteristic to each of the first plurality of use cases that is applicable across multiple domains.

3. The method of claim 1, further comprising the step of:
generating additional use cases for the first domain, based at least in part on the relationship between the second plurality of use cases and the first domain.

4. The method of claim 1, further comprising the step of:
mapping the first plurality of use cases to a plurality of applications in the first domain.

5. The method of claim 4, further comprising the step of:
determining a severity for each of the first plurality of use cases, based at least in part on the mapping.

6. The method of claim 1, wherein:
the first domain comprises an aerospace domain; and
the second domain comprises a land vehicle domain.

7. A program product for generating a repository of use cases for developing a solution or evaluating a solution, or both, in a first domain, the program product comprising:
a program configured to at least facilitate:
obtaining a first plurality of use cases for the first domain;
obtaining a second plurality of use cases for a second domain; and
determining a relationship between the second plurality of use cases and the first domain; and
a computer-readable signal-bearing media bearing the program.

8. The program product of claim 7, wherein the program is further configured to at least facilitate:
assigning a generic characteristic to each of the first plurality of use cases that is applicable across multiple domains.

9. The program product of claim 7, wherein the program is further configured to at least facilitate:
generating additional use cases for the first domain, based at least in part on the relationship between the second plurality of use cases and the first domain.

10. The program product of claim 7, wherein the program is further configured to at least facilitate:
mapping the first plurality of use cases to a plurality of applications in the first domain.

11. A method for preparing a set of use cases to develop a solution or evaluate a solution, or both, in a first domain, the method comprising the steps of:
determining which of a first plurality of use cases pertaining to the first domain are applicable for the solution, to thereby select a first plurality of applicable use cases; and
determining which of a second plurality of use cases pertaining to a second domain are applicable for the solution, to thereby select a second plurality of applicable use cases, based at least in part on a relationship between the second plurality of use cases and the first domain.

12. The method of claim 11, further comprising the step of:
retrieving the first plurality of applicable use cases and the second plurality of applicable use cases from a central repository of use cases.

13. The method of claim 12, further comprising the steps of:
obtaining a security measure from a user; and
allowing the user to access the first plurality of applicable use cases or the second plurality of applicable use cases, or both, only if the security measure is valid.

14. The method of claim 13, further comprising the step of:
adjusting the first plurality of applicable use cases, the second plurality of applicable use cases, or both, if requested by the user.

15. The method of claim 14, further comprising the step of:
generating additional applicable use cases if requested by the user.

16. The method of claim 13, further comprising the step of:
generating a plurality of projects using applicable use cases selected by the user.

17. A program product for preparing a set of use cases to develop a solution or evaluate a solution, or both, in a first domain, the program product comprising:
a program configured to at least facilitate:
determining which of a first plurality of use cases pertaining to the first domain are applicable for the solution, to thereby select a first plurality of applicable use cases; and
determining which of a second plurality of use cases pertaining to a second domain are applicable for the solution, to thereby select a second plurality of applicable use cases, based at least in part on a relationship between the second plurality of use cases and the first domain; and
a computer-readable signal-bearing media bearing the program.

18. The program product of claim 17, wherein the program is further configured to at least facilitate:
retrieving the first plurality of applicable use cases and the second plurality of applicable use cases from a central repository of use cases

19. The program product of claim 18, wherein the program is further configured to at least facilitate:
obtaining a security measure from a user; and
allowing the user to access the first plurality of applicable use cases and the second plurality of applicable use cases, only if the security measure is valid.

20. The program product of claim 19, wherein the program is further configured to at least facilitate:
adjusting the first plurality of applicable use cases, the second plurality of applicable use cases, or both, if requested by the user.

21. The program product of claim 20, wherein the program is further configured to at least facilitate:
generating additional applicable use cases if requested by the user.

22. A use case management system comprising:
a repository of use cases for developing a solution or evaluating a solution, or both, in a plurality of domains, the repository of use cases comprising a first plurality of use cases from a first domain, a second plurality of use cases from a second domain, and a relationship between the first plurality of use cases and the second domain; and
a server module coupled to the repository and configured to allow a user to interface with the repository.

23. The use case management system of claim 22, wherein the server module is further configured to at least facilitate receiving instructions from the user and managing the repository in accordance with the instructions.

24. The use case management system of claim 23, wherein the server module is further configured to at least facilitate customizing the repository in accordance with the instructions.

25. The use case management system of claim 22, wherein the server module is further configured to at least facilitate:
obtaining a security measure from a user; and
allowing the user to access the first plurality of applicable use cases or the second plurality of applicable use cases, or both, only if the security measure is valid.
